(19) United States
(12) Patent Application Publication
(10) Pub. No.: US 2026/0351813 A1
(43) Pub. Date: Nov. 5, 2026

(54) BATTERY CELL AND ELECTRICAL APPARATUS

(71) Applicant: NINGDE AMPEREX TECHNOLOGY LIMITED, Ningde (CN)

(72) Inventors: Jiaxiao YAN, Ningde (CN); Xinghua TAO, Ningde (CN); Fang LV, Ningde (CN); Changming QU, Ningde (CN)

(73) Assignee: NINGDE AMPEREX TECHNOLOGY LIMITED, Ningde (CN)

(21) Appl. No.: 19/722,121

(22) Filed: Jun. 26, 2026

Related U.S. Application Data
(63) Continuation of application No. PCT/CN2024/141499, filed on Dec. 23, 2024.

(30) Foreign Application Priority Data
Dec. 28, 2023 (CN) 202311843801.X

(51) Int. Cl. H01M 50/54; H01M 4/66; H01M 10/04; H01M 50/533; H01M 50/536

(52) U.S. Cl. CPC H01M 50/54; H01M 4/667; H01M 10/0413; H01M 50/533; H01M 50/536

(57) ABSTRACT

A battery cell includes an electrode assembly, a tab, and a tab lead. The tab includes a plurality of tab units, where the respective one ends of the plurality of tab units are gathered and form a root, a first connecting portion, a first extending portion, a second connecting portion, and a second extending portion that are sequentially connected. The root, the first extending portion, and the second extending portion are sequentially spaced apart on one side of the electrode assembly along the second direction, and the first connecting portion and the second connecting portion are respectively bent. The second direction is perpendicular to the first direction. A portion of the tab lead and the second extending portion overlap in the second direction, and a second weld mark is provided in the overlapping region of the tab lead and the second extending portion.

### CROSS-REFERENCE TO RELATED APPLICATIONS

This application is a continuation application of International Application No. PCT/CN2024/141499, filed on Dec. 23, 2024, which claims the benefit of priority of Chinese patent application 202311843801.X, filed on Dec. 28, 2023, the contents of which are incorporated herein by reference in its entirety.

### TECHNICAL FIELD

The present application relates to the field of energy storage technology, and in particular, to a battery cell and an electrical apparatus.

### BACKGROUND

In existing battery cells, as shown in FIG. 1, a roll weld mark 91 is provided at the connection between a tab and an electrode assembly, and a transition weld mark 92 is provided at the connection between the tab and a tab lead. One end of the roll weld mark 91 is adjacent to the electrode assembly, and another end of the roll weld mark 91 is bent and spaced apart from the transition weld mark 92 along the thickness direction of the battery cell. The tab segment between the roll weld mark 91 and the transition weld mark 92 is configured to reserve a spacing to reduce the risk of interference between the roll weld mark 91 and the transition weld mark 92.

Since the tab segment between the roll weld mark 91 and the transition weld mark 92 extends along the thickness direction of the battery cell, and in the thickness direction of the battery cell, the bent portion of the roll weld mark 91 and the portion of the tab lead outside the transition weld mark 92 do not share a common height space, this results in the tab and the tab lead occupying a larger space in the thickness direction of the battery cell, which is not conducive to improving the energy density of the battery cell.

### SUMMARY

In view of the above situation, it is necessary to provide a battery cell that is conducive to improving the energy density of the battery cell.

An embodiment of the present application provides a battery cell, where the battery cell includes an electrode assembly, a tab, and a tab lead. The tab includes a plurality of tab units, where the respective one ends of the plurality of tab units are arranged along a first direction and respectively connected to one side of the electrode assembly in a second direction, and the respective another ends of the plurality of tab units are gathered and form a root, a first connecting portion, a first extending portion, a second connecting portion, and a second extending portion that are sequentially connected. The root, the first extending portion, and the second extending portion are sequentially arranged on one side of the electrode assembly along the second direction, and the first connecting portion and the second connecting portion are respectively bent. The plurality of tab units are interconnected and provided with a first weld mark, where one end of the first weld mark is located at the root, and another end of the first weld mark extends through the first connecting portion to the first extending portion. The first direction is a thickness direction of the electrode assembly, and the second direction is perpendicular to the first direction. A portion of the tab lead and the second extending portion overlap in the second direction, and a second weld mark is provided in the overlapping region of the tab lead and the second extending portion.

In the above battery cell, the first extending portion and the second extending portion are sequentially arranged on one side of the electrode assembly along the second direction, the first connecting portion and the second connecting portion are respectively bent, one end of the first weld mark is located at the root, another end of the first weld mark extends through the first connecting portion to the first extending portion, and the second weld mark is provided on the second extending portion.

Through the above arrangement, the tab segment between the first weld mark and the second weld mark extends along the bending direction of the second connecting portion, which can reduce the height occupied by the tab segment in the first direction while reserving a spacing between the first weld mark and the second weld mark. Furthermore, it facilitates the bent portion of the first weld mark (that is, the portion of the first weld mark located at the first connecting portion) and the portion of the tab lead outside the second weld mark to share a common height space in the first direction. This is conducive to improving the space utilization rate of the tab and the tab lead in the first direction, thereby increasing the energy density of the battery cell.

In some embodiments of the present application, along an extending direction of the tab, a spacing S1 between the first weld mark and the second weld mark satisfies: 0.5 mm≤S1≤2 mm. When S1 is too small (for example, less than 0.5 mm), it is easy for the first weld mark and the second weld mark to interfere with each other during the welding process, affecting the reliability of the welding; when S1 is too large (for example, greater than 2 mm), it leads to a longer extension length of the tab segment between the first weld mark and the second weld mark, resulting in space waste. By defining 0.5 mm≤S1≤2 mm, the risk of interference between the first weld mark and the second weld mark during the welding process is reduced, the reliability of the welding is improved, and it facilitates improving the space utilization rate of the tab on the side of the electrode assembly, thereby contributing to increasing the energy density of the battery cell. Along the second direction, a projection of a portion of the first weld mark located at the first extending portion and the second weld mark do not overlap, so that the region of the second extending portion not provided with the second weld mark is arranged opposite to the first weld mark along the second direction, and the region of the first extending portion not provided with the first weld mark is arranged opposite to the second weld mark along the second direction, which is conducive to reducing the risk of interference between the first weld mark and the second weld mark during the welding process, thereby improving the reliability of the welding.

In some embodiments of the present application, along the second direction, a projection of the tab and a projection of the tab lead are respectively located within a projection range of the electrode assembly to reduce the space waste caused by the tab and the tab lead extending beyond the electrode assembly in the first direction, facilitating the improvement of the space utilization rate of the tab and the tab lead in the first direction, thereby contributing to increasing the energy density of the battery cell.

In some embodiments of the present application, the tab lead includes a third extending portion, a third connecting portion, and a fourth extending portion that are sequentially connected. The third extending portion is arranged along the second direction on the side of the second extending portion facing the electrode assembly, at least a portion of the third extending portion and the second extending portion overlap in the second direction, and the second weld mark is provided in the overlapping region of the third extending portion and the second extending portion. The third connecting portion is bent, which is conducive to relieving the stress of the bending of the tab lead. The fourth extending portion extends away from the electrode assembly along the second direction to facilitate electrical connection with an external circuit.

In some embodiments of the present application, the first extending portion, the second extending portion, and the third extending portion respectively extend substantially along the first direction, so that the first extending portion, the second extending portion, and the third extending portion are arranged along the second direction on one side of the electrode assembly, which is conducive to making the stress on each bent portion of the tab and the tab lead uniform, reducing the risk of rebound or fracture of the tab and the tab lead.

In some embodiments of the present application, along the first direction, a thickness H1 of the electrode assembly satisfies: H1≤3.8 mm. In existing battery cells, since the tab segment between the roll weld mark and the transition weld mark extends along the thickness direction of the battery cell, and in the thickness direction of the battery cell, the bent portion of the roll weld mark and the portion of the tab lead outside the transition weld mark do not share a common height space, this results in a thicker battery cell (greater than 3.8 mm). By having the tab segment between the first weld mark and the second weld mark extend along the bending direction of the second connecting portion, the bent portion of the first weld mark (that is, the portion of the first weld mark located at the first connecting portion) and the portion of the tab lead outside the second weld mark share a common height space in the first direction, which can reduce the thickness of the battery cell, facilitating the miniaturization of the battery cell.

In some embodiments of the present application, along the first direction, a height H2 from an endpoint where the third connecting portion connects to the third extending portion to a surface of the fourth extending portion facing away from the third extending portion satisfies: 0.5 mm≤H2≤0.7 mm. When H2 is too small (for example, less than 0.5 mm), it easily leads to a smaller range of bending angles for the fourth extending portion around the endpoint where the third connecting portion connects to the third extending portion, making it inconvenient to adjust the angle of connection between the fourth extending portion and the external circuit; when H2 is too large (for example, greater than 0.7 mm), it easily leads to a larger space occupied by the third connecting portion and the fourth extending portion in the first direction, resulting in space waste. By defining 0.5 mm≤H2≤0.7 mm, it facilitates adjusting the angle of connection between the fourth extending portion and the external circuit and improves the space utilization rate of the third connecting portion and the fourth extending portion in the first direction, thereby contributing to increasing the energy density of the battery cell.

In some embodiments of the present application, along the first direction, a height H3 from an endpoint where the third extending portion connects to the third connecting portion to a surface of the second connecting portion facing away from the second extending portion satisfies: 1 mm≤H3≤1.5 mm. When H3 is too small (for example, less than 1 mm), it easily leads to a smaller overlapping region between the tab lead and the second extending portion, resulting in higher welding difficulty and lower connection strength for the second weld mark; when H3 is too large (for example, greater than 1.5 mm), it easily leads to a larger space occupied by the second connecting portion, the second extending portion, and the third extending portion in the first direction, resulting in space waste. By defining 1 mm≤H3≤1.5 mm, it facilitates reducing the welding difficulty of the second weld mark and improving the connection strength of the second weld mark, and improves the space utilization rate of the second connecting portion, the second extending portion, and the third extending portion in the first direction, thereby contributing to increasing the energy density of the battery cell.

In some embodiments of the present application, the first extending portion extends along the first direction, and the second extending portion and the third extending portion both extend along a same direction inclined relative to the first direction. Along an extending direction of the tab, the extension length W1 from the endpoint where the third extending portion connects to the third connecting portion to the surface of the second connecting portion facing away from the second extending portion and an inclination angle α of the second extending portion and the third extending portion relative to the first direction satisfy: α>arccos(H3/W1), so that the fourth extending portion extends outward along the second direction under the inclined arrangement of the third extending portion to connect with an external circuit without affecting the thickness of the battery.

In some embodiments of the present application, the electrode assembly includes a first electrode plate, a separator, and a second electrode plate sequentially stacked along the first direction. The first electrode plate includes a first current collector, a first active material layer, and a conductive member. The first current collector includes a first section and a second section sequentially arranged in the second direction. The first active material layer is connected to the first section. When viewed along the first direction, one end of the conductive member is connected to the second section, and another end of the conductive member protrudes beyond the first current collector in the second direction and is connected to the tab unit.

In some embodiments of the present application, the first current collector includes a support layer, a first conductive layer, and a second conductive layer arranged on two sides of the support layer in the first direction. The first active material layer is connected to the first conductive layer and/or the second conductive layer located at the first section, and the conductive member is connected to the first conductive layer and/or the second conductive layer located at the second section. When the first current collector is subjected to mechanical damage due to external force impact, the first conductive layer and the second conductive layer help reduce the generation of metal burrs, thereby reducing the risk of short circuits.

In some embodiments of the present application, the battery cell further includes an insulating member, where one end of the insulating member is adhered to a surface of the first active material layer facing away from the first current collector and another end of the insulating member is adhered to a surface of the conductive member facing away from the first current collector. The insulating member is configured to enhance insulation isolation of the corresponding covered region in the first direction from other structural components, reducing the risk of short circuits and improving the reliability of the battery cell.

An embodiment of the present application also provides an electrical apparatus, including the battery cell according to any one of the above embodiments. In the above battery cell and electrical apparatus, the first extending portion

and the second extending portion are sequentially arranged on one side of the electrode assembly along the second direction, the first connecting portion and the second connecting portion are respectively bent, one end of the first weld mark is located at the root, another end of the first weld mark extends through the first connecting portion to the first extending portion, and the second weld mark is provided on the second extending portion. Through the above arrangement, the tab segment between the first weld mark and the second weld mark extends along the bending direction of the second connecting portion, which can reduce the height occupied by the tab segment in the first direction while reserving a spacing between the first weld mark and the second weld mark. Furthermore, it facilitates the bent portion of the first weld mark (that is, the portion of the first weld mark located at the first connecting portion) and the portion of the tab lead outside the second weld mark to share a common height space in the first direction. This is conducive to improving the space utilization rate of the tab and the tab lead in the first direction, thereby increasing the energy density of the battery cell.

### BRIEF DESCRIPTION OF DRAWINGS

FIG. 1 is a schematic structural diagram of a battery cell provided in the prior art.

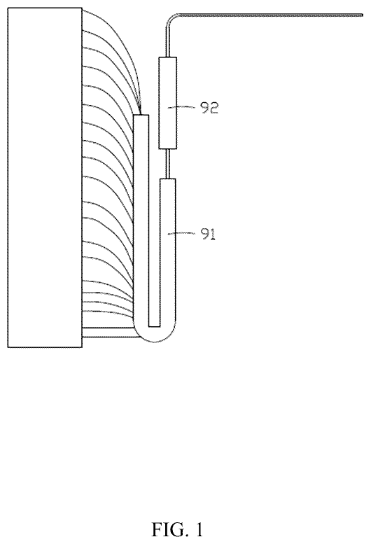

FIG. 2 is a schematic structural diagram of a battery cell in an embodiment of the present application.

FIG. 3 is a schematic structural diagram of a battery cell in another embodiment of the present application.

FIG. 4 is a schematic structural diagram of a packaging bag of a battery cell in an embodiment of the present application.

FIG. 5 is a schematic structural diagram of an electrode assembly of a battery cell in an embodiment of the present application.

FIG. 6 is a schematic structural diagram of a first electrode plate of a battery cell in an embodiment of the present application.

FIG. 7 is a schematic structural diagram of an insulating member of a battery cell in an embodiment of the present application.

FIG. 8 is a schematic structural diagram of an electrical apparatus in an embodiment of the present application.

Description of reference signs

| | |
|---|---|
| Battery cell | 100 |
| Electrical apparatus | 200 |
| Electrode assembly | 10 |
| First electrode plate | 11 |
| First current collector | 111 |
| First section | 111a |
| Second section | 111b |
| Support layer | 1111 |
| First conductive layer | 1112 |
| Second conductive layer | 1113 |
| First active material layer | 112 |
| Conductive member | 113 |
| Separator | 12 |
| Second electrode plate | 13 |
| Tab | 20 |
| Tab unit | 20a |
| Root | 21 |
| First connecting portion | 22 |
| First extending portion | 23 |
| Second connecting portion | 24 |
| Second extending portion | 25 |
| Tab lead | 30 |
| Endpoint | 301 |
| Third extending portion | 31 |
| Third connecting portion | 32 |
| Fourth extending portion | 33 |
| First weld mark | 41 |
| Second weld mark | 42 |
| Packaging bag | 50 |
| Gel | 60 |
| Insulating member | 70 |
| First direction | Z |
| Second direction | X |
| Roll weld mark | 91 |
| Transition weld mark | 92 |

The following detailed description will further illustrate the present application in conjunction with the above drawings.

### DETAILED DESCRIPTION

The technical solutions in the embodiments of the present application will be described below with reference to the drawings in the embodiments of the present application. It is apparent that the described embodiments are only a part of the embodiments of the present application, and not all of them.

It should be noted that when an element is considered to be “connected” to another element, it may be directly connected to the other element or there may be intervening elements present. When an element is considered to be “disposed” on another element, it may be directly disposed on the other element or there may be intervening elements present. When a value is considered to be “equal” to another value, it means that the two are equal within a set deviation, with the set deviation range being within 5%, that is, when at least one of the two values fluctuates within the set deviation range, even if their values are not equal, they are still deemed substantially equal. When a value is considered to have a ratio of “1:1” with another value, it means that the two are equal within a set deviation, with the set deviation range being within 5%, that is, when at least one of the two values fluctuates within the set deviation range, even if their values are not equal, their ratio is still deemed equal.

Unless otherwise defined, all technical and scientific terms used herein have the same meaning as commonly understood by those skilled in the technical field of the present application. The terms used herein in the specification of the present application are only for the purpose of describing specific embodiments and are not intended to limit the present application. The term “and/or” as used herein includes any and all combinations of one or more of the associated listed items.

It should be understood that, considering factors of actual processing tolerances, the term “perpendicular” in the technical solutions of the present application is used to describe an ideal state between two components. In actual production or use, there may be an approximately perpendicular state between two components. For example, in combination with numerical descriptions, perpendicular may refer to an angle range between two straight lines of 90°±10°, perpendicular may also refer to a dihedral angle range between two planes of 90°±10°, and perpendicular may also refer to an angle range between a straight line and a plane of 90°=10°. The two components described as “perpendicular” may not be absolutely straight lines or planes; they may be substantially straight lines or planes, and as long as their overall extending direction is a straight line or plane from a macroscopic perspective, they can be considered as “straight lines” or “planes.”

An embodiment of the present application provides a battery cell, where the battery cell includes an electrode assembly, a tab, and a tab lead. The tab includes a plurality of tab units, where the respective one ends of the plurality of tab units are arranged along a first direction and respectively connected to one side of the electrode assembly in a second direction, and the respective another ends of the plurality of tab units are gathered and form a root, a first connecting portion, a first extending portion, a second connecting portion, and a second extending portion that are sequentially connected. The root, the first extending portion, and the second extending portion are sequentially arranged on one side of the electrode assembly along the second direction, and the first connecting portion and the second connecting portion are respectively bent. The plurality of tab units are interconnected and provided with a first weld mark, where one end of the first weld mark is located at the root, and another end of the first weld mark extends through the first connecting portion to the first extending portion. The first direction is a thickness direction of the electrode assembly, and the second direction is perpendicular to the first direction. A portion of the tab lead and the second extending portion overlap in the second direction, and a second weld mark is provided in the overlapping region of the tab lead and the second extending portion.

In the above battery cell, the first extending portion and the second extending portion are sequentially arranged on one side of the electrode assembly along the second direction, the first connecting portion and the second connecting portion are respectively bent, one end of the first weld mark is located at the root, another end of the first weld mark extends through the first connecting portion to the first extending portion, and the second weld mark is provided on the second extending portion. Through the above arrangement, the tab segment between the first weld mark and the second weld mark extends along the bending direction of the second connecting portion, which can reduce the height occupied by the tab segment in the first direction while reserving a spacing between the first weld mark and the second weld mark. Furthermore, it facilitates the bent portion of the first weld mark (that is, the portion of the first weld mark located at the first connecting portion) and the portion of the tab lead outside the second weld mark to share a common height space in the first direction. This is conducive to improving the space utilization rate of the tab and the tab lead in the first direction, thereby increasing the energy density of the battery cell.

The embodiments of the present application will be further described below in conjunction with the drawings.

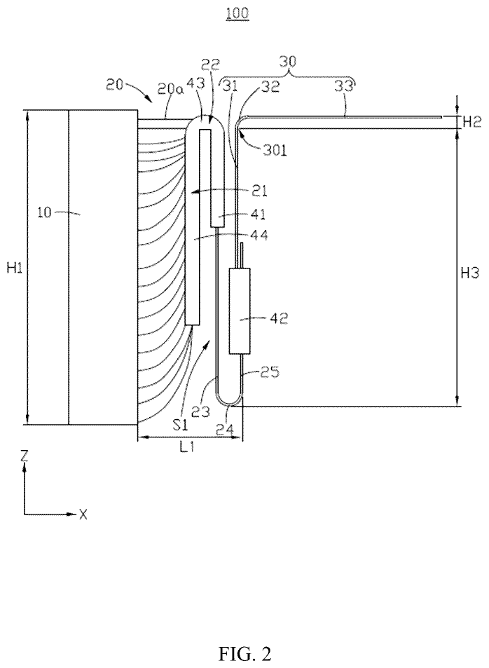

Referring to FIG. 2, an embodiment of the present application provides a battery cell 100. The battery cell 100 may, but is not limited to, be applied in a secondary battery, where a secondary battery refers to a battery that can be recharged to activate the active material for continued use after discharge.

The battery cell 100 includes an electrode assembly 10, a tab 20, and a tab lead 30. The electrode assembly 10 is configured to convert chemical energy into electrical energy. The electrode assembly 10 includes a positive electrode plate, a separator, and a negative electrode plate arranged sequentially, where optionally, the positive electrode plate, the separator, and the negative electrode plate have a wound structure or a laminated structure.

The tab 20 includes a plurality of tab units 20a, where the plurality of tab units 20a have the same polarity, that is, the plurality of tab units 20a are all connected to the positive electrode plate, or the plurality of tab units 20a are all connected to the negative electrode plate.

The respective one ends of the plurality of tab units 20a are spaced apart along a first direction Z and respectively connected to one side of the electrode assembly 10 in a second direction X. The first direction Z is a thickness direction of the electrode assembly 10, and the second direction X is perpendicular to the first direction Z. The respective another ends of the plurality of tab units 20a are gathered and form a root 21, a first connecting portion 22, a first extending portion 23, a second connecting portion 24, and a second extending portion 25 that are sequentially connected, to facilitate cutting and shaping of the tab 20 during the preparation process.

The root 21, the first extending portion 23, and the second extending portion 25 are sequentially arranged on one side of the electrode assembly 10 along the second direction X. The first connecting portion 22 and the second connecting portion 24 are respectively bent, so that the root 21, the first connecting portion 22, and the first extending portion 23 form a U-shaped structure, and the first extending portion 23, the second connecting portion 24, and the second extending portion 25 form a U-shaped structure, with the openings of the two U-shaped structures facing opposite directions. The first connecting portion 22 is configured to provide an arc-shaped transition between the root 21 and the first extending portion 23, and the second connecting portion 24 is configured to provide an arc-shaped transition between the first extending portion 23 and the second extending portion 25, which is conducive to relieving the stress of the bending of the tab 20.

The plurality of tab units 20a are interconnected and provided with a first weld mark 41, where one end of the first weld mark 41 is located at the root 21, and another end of the first weld mark 41 extends through the first connecting portion 22 to the first extending portion 23. The first weld mark 41 is configured to enhance the structural stability of the tab 20. Specifically, the first weld mark 41 is formed by roll welding.

A portion of the tab lead 30 and the second extending portion 25 overlap in the second direction X, and a second weld mark 42 is provided in the overlapping region of the tab lead 30 and the second extending portion 25, where the second weld mark 42 is configured to enhance the connection strength between the tab lead 30 and the second extending portion 25. Specifically, the second weld mark 42 is formed by transition welding. The portion of the tab lead 30 outside the second weld mark 42 is configured to electrically connect with an external circuit.

In the above battery cell 100, the first extending portion 23 and the second extending portion 25 are sequentially arranged on one side of the electrode assembly 10 along the second direction X, the first connecting portion 22 and the second connecting portion 24 are respectively bent, one end of the first weld mark 41 is located at the root 21, another end of the first weld mark 41 extends through the first connecting portion 22 to the first extending portion 23, and the second weld mark 42 is provided on the second extending portion 25. Through the above arrangement, the tab segment between the first weld mark 41 and the second weld mark 42 extends along the bending direction of the second connecting portion 24, which can reduce the height occupied by the tab segment in the first direction Z while reserving a spacing between the first weld mark 41 and the second weld mark 42. Furthermore, it facilitates the bent portion of the first weld mark 41 (that is, the portion of the first weld mark located at the first connecting portion 22) and the portion of the tab lead 30 outside the second weld mark 42 to share a common height space in the first direction Z. This is conducive to improving the space utilization rate of the tab 20 and the tab lead 30 in the first direction Z, thereby increasing the energy density of the battery cell 100.

Referring to FIG. 2, in some embodiments, along an extending direction of the tab 20, a spacing S1 between the first weld mark 41 and the second weld mark 42 (that is, the extension length of the tab segment between the first weld mark 41 and the second weld mark 42) satisfies: 0.5 mm≤S1≤2 mm. When S1 is too small (for example, less than 0.5 mm), it is easy for the first weld mark 41 and the second weld mark 42 to interfere with each other during the welding process, affecting the reliability of the welding; when S1 is too large (for example, greater than 2 mm), it leads to a longer extension length of the tab segment between the first weld mark 41 and the second weld mark 42, resulting in space waste. By defining 0.5 mm≤S1≤2 mm, the risk of interference between the first weld mark 41 and the second weld mark 42 during the welding process is reduced, the reliability of the welding is improved, and it facilitates improving the space utilization rate of the tab 20 on the side of the electrode assembly 10, thereby contributing to increasing the energy density of the battery cell 100.

Optionally, S1 may be one of 0.5 mm, 0.55 mm, 0.6 mm, 0.65 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, or any other value within the range of 0.5 mm≤S1≤2 mm.

Further, 0.5 mm≤S1≤0.65 mm is satisfied, to further reduce the risk of interference between the first weld mark 41 and the second weld mark 42 during the welding process, improve the reliability of the welding, and facilitate improving the space utilization rate of the tab 20 on the side of the electrode assembly 10, thereby contributing to increasing the energy density of the battery cell 100.

In some embodiments, along the second direction X, a projection of a portion of the first weld mark 41 located at the first extending portion 23 and the second weld mark 42 do not overlap, so that the region of the second extending portion 25 not provided with the second weld mark 42 is arranged opposite to the first weld mark 41 along the second direction X, and the region of the first extending portion 23 not provided with the first weld mark 41 is arranged opposite to the second weld mark 42 along the second direction X, which is conducive to reducing the risk of interference between the first weld mark 41 and the second weld mark 42 during the welding process, thereby improving the reliability of the welding.

In some embodiments, along the first direction Z, the projection of the portion of the first weld mark 41 located at the first extending portion 23 and the projection of the second weld mark 42 partially overlap, to reduce the space occupied by the first weld mark 41 and the second weld mark 42 in the second direction X, thereby contributing to increasing the energy density of the battery cell 100.

Referring to FIG. 2, in some embodiments, along the second direction X, a projection of the tab 20 and a projection of the tab lead 30 are respectively located within a projection range of the electrode assembly 10, to reduce the space waste caused by the tab 20 and the tab lead 30 extending beyond the electrode assembly 10 in the first direction Z, facilitating the improvement of the space utilization rate of the tab 20 and the tab lead 30 in the first direction Z, thereby contributing to increasing the energy density of the battery cell 100.

Referring to FIG. 2, in some embodiments, the tab lead 30 includes a third extending portion 31, a third connecting portion 32, and a fourth extending portion 33 that are sequentially connected. The third extending portion 31 is arranged along the second direction X on a side of the second extending portion 25 facing the electrode assembly 10. At least a portion of the third extending portion 31 and the second extending portion 25 overlap in the second direction X, and the second weld mark 42 is provided in the overlapping region of the third extending portion 31 and the second extending portion 25. The third connecting portion 32 is bent, and the third connecting portion 32 is configured to provide an arc-shaped transition between the third extending portion 31 and the fourth extending portion 33, which is conducive to relieving the stress of the bending of the tab lead 30. The fourth extending portion 33 extends away from the electrode assembly 10 along the second direction X to facilitate electrical connection with an external circuit.

In some embodiments, the first extending portion 23, the second extending portion 25, and the third extending portion 31 respectively extend substantially along the first direction Z, so that the first extending portion 23, the second extending portion 25, and the third extending portion 31 are arranged along the second direction X on one side of the electrode assembly 10, which is conducive to making the stress on each bent portion of the tab 20 and the tab lead 30 uniform, reducing the risk of rebound or fracture of the tab 20 and the tab lead 30.

It should be noted that extending substantially along the first direction Z refers to a range of angle between the extending direction and the first direction Z being within 180°±10°. In some embodiments, the root 21 extends substantially along the first direction Z, which is conducive to making the stress on each bent portion of the tab unit 20a uniform, reducing the risk of rebound or fracture of the tab 20.

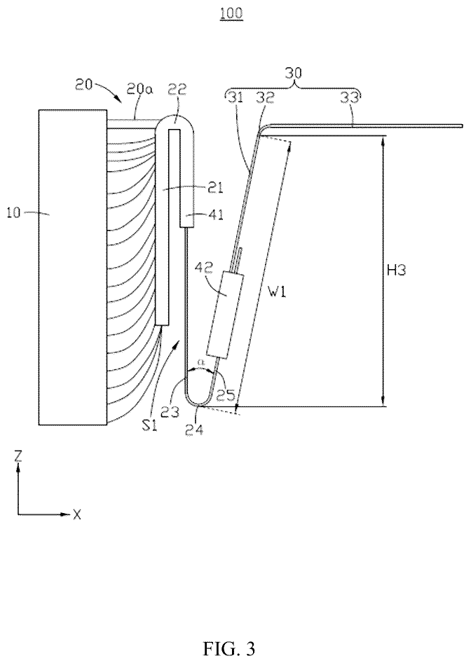

Referring to FIG. 3, it can be understood that, in other embodiments, at least one of the first extending portion 23, the second extending portion 25, and the third extending portion 31 is inclined relative to the first direction Z to adapt to the spacing between the electrode assembly 10 and an external circuit.

Referring to FIG. 2 again, in some embodiments, along the first direction Z, a thickness H1 of the electrode assembly 10 satisfies: H1≤3.8 mm. In existing battery cells, since the tab segment between the roll weld mark and the transition weld mark extends along the thickness direction of the battery cell, and in the thickness direction of the battery cell, the bent portion of the roll weld mark and the portion of the tab lead outside the transition weld mark do not share a common height space, this results in a thicker battery cell (greater than 3.8 mm). In the present application, by having the tab segment between the first weld mark 41 and the second weld mark 42 extend along the bending direction of the second connecting portion 24, the bent portion of the first weld mark 41 (that is, the portion of the first weld mark located at the first connecting portion 22) and the portion of the tab lead 30 outside the second weld mark 42 share a common height space in the first direction Z, which can reduce the thickness of the battery cell 100, making H1≤3.8 mm, facilitating the miniaturization of the battery cell 100.

Further, 2.5 mm≤H1≤3.8 mm is satisfied to reserve space for arranging the tab 20 and the tab lead 30 in the first direction Z, and to facilitate the miniaturization of the battery cell 100.

Optionally, H1 may be one of 2.5 mm, 2.6 mm, 2.7 mm, 2.8 mm, 2.9 mm, 3 mm, 3.1 mm, 3.2 mm, 3.3 mm, 3.4 mm, 3.5 mm, 4 mm, 4.5 mm, 5 mm, or any other value within the range of H1≥2.5 mm.

In some embodiments, along the first direction Z, a height H2 from an endpoint 301 where the third connecting portion 32 connects to the third extending portion 31 to a surface of the fourth extending portion 33 facing away from the third extending portion 31 satisfies: 0.5 mm≤H2≤0.7 mm. When H2 is too small (for example, less than 0.5 mm), it easily leads to a smaller range of bending angles for the fourth extending portion 33 around the endpoint 301 where the third connecting portion 32 connects to the third extending portion 31, making it inconvenient to adjust the angle of connection between the fourth extending portion 33 and an external circuit; when H2 is too large (for example, greater than 0.7 mm), it easily leads to a larger space occupied by the third connecting portion 32 and the fourth extending portion 33 in the first direction Z, resulting in space waste. By defining 0.5 mm≤H2≤0.7 mm, it facilitates adjusting the angle of connection between the fourth extending portion 33 and an external circuit and improves the space utilization rate of the third connecting portion 32 and the fourth extending portion 33 in the first direction Z, thereby contributing to increasing the energy density of the battery cell 100.

Optionally, H2 may be one of 0.5 mm, 0.51 mm, 0.52 mm, 0.53 mm, 0.54 mm, 0.55 mm, 0.56 mm, 0.57 mm, 0.58 mm, 0.59 mm, 0.6 mm, 0.61 mm, 0.62 mm, 0.63 mm, 0.64 mm, 0.65 mm, 0.66 mm, 0.67 mm, 0.68 mm, 0.69 mm, 0.7 mm, or any other value within the range of 0.5 mm≤H2≤0.7 mm.

Further, 0.58 mm≤H2≤0.62 mm is satisfied to further facilitate adjusting the angle of connection between the fourth extending portion 33 and an external circuit and to improve the space utilization rate of the third connecting portion 32 and the fourth extending portion 33 in the first direction Z, thereby contributing to increasing the energy density of the battery cell 100.

In some embodiments, along the first direction Z, a height H3 from an endpoint 301 where the third extending portion 31 connects to the third connecting portion 32 to a surface of the second connecting portion 24 facing away from the second extending portion 25 satisfies: 1 mm≤H3≤1.5 mm. When H3 is too small (for example, less than 1 mm), it easily leads to a smaller overlapping region between the tab lead 30 and the second extending portion 25, resulting in higher welding difficulty and lower connection strength for the second weld mark 42; when H3 is too large (for example, greater than 1.5 mm), it easily leads to a larger space occupied by the second connecting portion 24, the second extending portion 25, and the third extending portion 31 in the first direction Z, resulting in space waste. By defining 1 mm≤H3≤1.5 mm, it facilitates reducing the welding difficulty of the second weld mark 42 and improving the connection strength of the second weld mark 42, and improves the space utilization rate of the second connecting portion 24, the second extending portion 25, and the third extending portion 31 in the first direction Z, thereby contributing to increasing the energy density of the battery cell 100.

Optionally, H3 may be one of 1 mm, 1.1 mm, 1.2 mm, 1.3 mm, 1.4 mm, 1.5 mm, or any other value within the range of 1 mm≤H3≤1.5 mm.

Further, 1.1 mm≤H3≤1.3 mm is satisfied to further facilitate reducing the welding difficulty of the second weld mark 42 and improving the connection strength of the second weld mark 42, and to improve the space utilization rate of the second connecting portion 24, the second extending portion 25, and the third extending portion 31 in the first direction Z, thereby contributing to increasing the energy density of the battery cell 100.

Referring to FIG. 3 again, in some embodiments, the first extending portion 23 extends along the first direction Z, and the second extending portion 25 and the third extending portion 31 both extend along a same direction inclined relative to the first direction Z. Along an extending direction of the tab 20, the extension length W1 from the endpoint 301 where the third extending portion 31 connects to the third connecting portion 32 to the surface of the second connecting portion 24 facing away from the second extending portion 25 and an inclination angle α of the second extending portion 25 and the third extending portion 31 relative to the first direction Z satisfy: α>arccos(H3/W1), so that the fourth extending portion 33 extends outward along the second direction X under the inclined arrangement of the third extending portion 31 to connect with an external circuit without the fourth extending portion 33 exceeding the thickness of the battery cell.

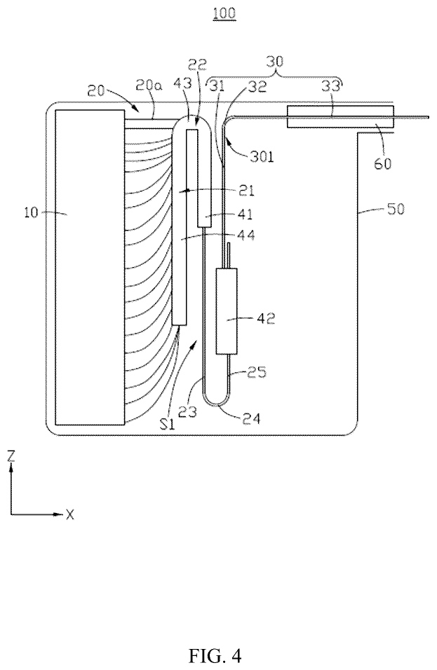

Referring to FIG. 4, in some embodiments, the battery cell 100 further includes a packaging bag 50, where the electrode assembly 10, the tab 20, the third extending portion 31, and the third connecting portion 32 are all accommodated in the packaging bag 50, and the end of the fourth extending portion 33 away from the third connecting portion 32 extends out of the packaging bag 50 for electrical connection with an external circuit.

In some embodiments, the battery cell 100 further includes a gel 60, where the gel 60 is disposed between the fourth extending portion 33 and the packaging bag 50 to enhance the connection strength and insulation stability between the tab lead 30 and the packaging bag 50.

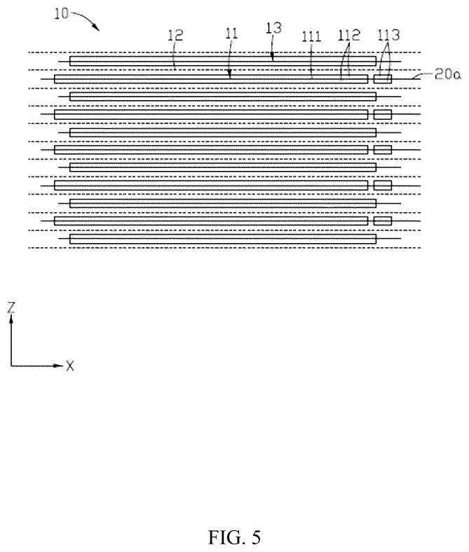

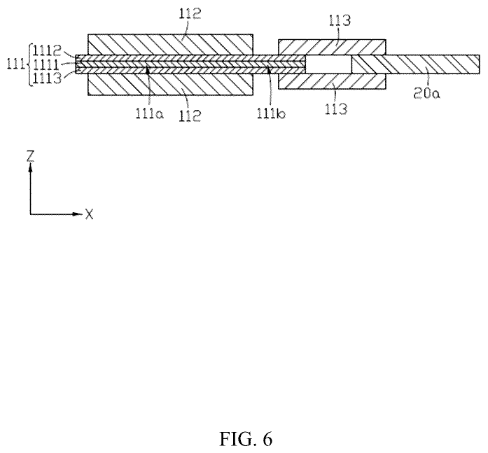

Referring to FIG. 5 and FIG. 6, in some embodiments, the electrode assembly 10 includes a first electrode plate 11, a separator 12, and a second electrode plate 13 sequentially stacked along the first direction Z. The first electrode plate 11 includes a first current collector 111, a first active material layer 112, and a conductive member 113. The first current collector 111 includes a first section 111a and a second section 111b sequentially arranged in the second direction X. The first active material layer 112 is connected to the first section 111a. When viewed along the first direction Z, one end of the conductive member 113 is connected to the second section 111b, and another end of the conductive member 113 protrudes beyond the first current collector 111 in the second direction X and is connected to the tab unit 20a.

The first current collector 111 includes a support layer 1111, and a first conductive layer 1112 and a second conductive layer 1113 arranged on two sides of the support layer 1111 in the first direction Z. The support layer 1111 is made of a polymer insulating material, which has high structural strength and low density and mass, enabling a reduction in the thickness and weight of the first current collector 111. Optionally, the polymer insulating material includes one or more of Polyethyleneterephthalate (Polyethyleneterephthalate, PET), Polypropylene (Polypropylene, PP), polyethylene (Polyethylene, PE), polyimide (Polyimide, PI), polyetherketone (Polyetherketone, PEK), and Polyphenylenesulphide (Polyphenylenesulphide, PPS).

The first conductive layer 1112 and the second conductive layer 1113 are made of metal materials. Compared to traditional metal current collectors, the first conductive layer 1112 and the second conductive layer 1113 arranged on two sides of the support layer 1111 are thinner, which helps reduce the generation of metal burrs when the first current collector 111 is subjected to mechanical damage due to external force impact, thereby reducing the risk of short circuits. Optionally, the metal material includes one or more of aluminum, copper, nickel, silver, gold, and iron.

The first active material layer 112 is connected to the first conductive layer 1112 and/or the second conductive layer 1113 located at the first section 111a. The first active material layer 112 is configured to generate current and collect the current to the first current collector 111. The conductive member 113 is connected to the first conductive layer 1112 and/or the second conductive layer 1113 located at the second section 111b, and the conductive member 113 is configured to connect with the tab unit 20a.

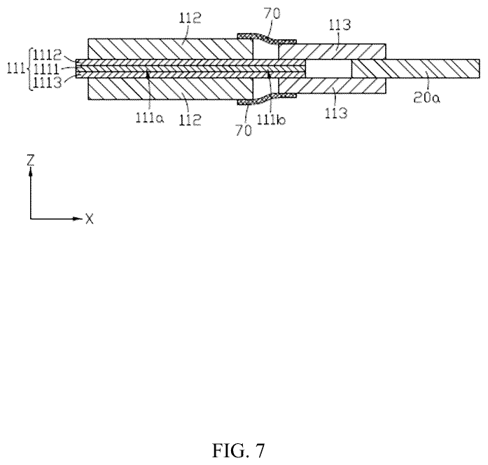

Referring to FIG. 7, the battery cell 100 further includes an insulating member 70, where one end of the insulating member 70 is adhered to a surface of the first active material layer 112 facing away from the first current collector 111 and another end of the insulating member 70 is adhered to a surface of the conductive member 113 facing away from the first current collector 111. The insulating member 70 is configured to enhance insulation isolation of the corresponding covered region in the first direction Z from other structural components (for example, the second electrode plate 13), reducing the risk of short circuits and improving the reliability of the battery cell 100.

It can be understood that the structure of the second electrode plate 13 may be the same as the structure of the first electrode plate 11.

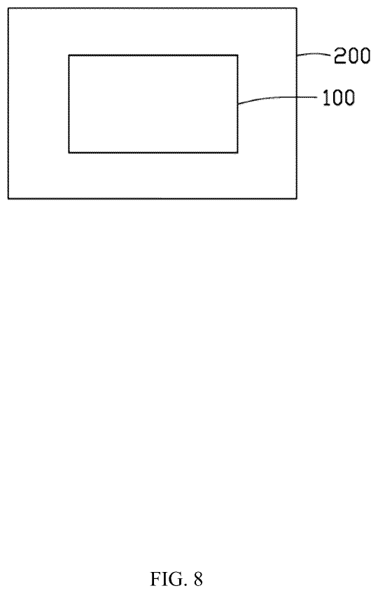

Referring to FIG. 8, an embodiment of the present application also provides an electrical apparatus 200, including the battery cell 100 according to any one of the above embodiments. The electrical apparatus 200 may be a vehicle, a mobile phone, a portable device, a laptop computer, a ship, a spacecraft, an electric toy, or an electric tool.

In summary, in the above battery cell 100 and electrical apparatus 200, the first extending portion 23 and the second extending portion 25 are sequentially arranged on one side of the electrode assembly 10 along the second direction X, the first connecting portion 22 and the second connecting portion 24 are respectively bent, one end of the first weld mark 41 is located at the root 21, another end of the first weld mark 41 extends through the first connecting portion 22 to the first extending portion 23, and the second weld mark 42 is provided on the second extending portion 25. Through the above arrangement, the tab segment between the first weld mark 41 and the second weld mark 42 extends along the bending direction of the second connecting portion 24, which can reduce the height occupied by the tab segment in the first direction Z while reserving a spacing between the first weld mark 41 and the second weld mark 42. Furthermore, it facilitates the bent portion of the first weld mark 41 (that is, the portion of the first weld mark located at the first connecting portion 22) and the portion of the tab lead 30 outside the second weld mark 42 to share a common height space in the first direction Z. This is conducive to improving the space utilization rate of the tab 20 and the tab lead 30 in the first direction Z, thereby increasing the energy density of the battery cell 100.

The following provides a detailed description of the present application based on examples through Table 1, but the present application is not limited to these examples.

Here, the extension length L1 (see FIG. 2) of the tab 20 in the length direction of the battery cell 100 is used as one parameter for comparison, where a longer extension length L1 indicates a larger space occupied by the tab 20. The tensile strength of the tab 20 is used as another parameter for comparison. It should be noted that the weld mark portions (the first weld mark 41 and the second weld mark 42) of the tab 20 have lower tensile strength compared to other portions of the tab 20, and during the stretching process of the tab 20, the weld mark portions of the tab 20 are prone to fracture and separation first. Therefore, the tensile strength of the tab 20 can reflect the welding reliability of the weld mark portions, where higher tensile strength indicates higher welding reliability, and lower tensile strength indicates lower welding reliability.

The tensile strength of the tab 20 in each example was measured by the following method: The electrode assembly 10 was fixed, a tensile testing machine was used to stretch the tab 20 at a constant rate of 60 mm/min, and the maximum tensile stress was recorded when the first weld mark 41 or the second weld mark 42 fractured.

The ratio of the maximum tensile stress to the cross-sectional area at the fracture is the tensile strength of the tab 20.

It should be noted that the battery cells in the examples have mostly the same parameters, for example, H1=2.5 mm when the insulating member 70 is not provided, and H1=3.2 mm when the insulating member 70 is provided; H2=0.6 mm; and H3=1.2 mm. Other parameters in the examples in the tables below are the same except for the parameters involved.

TABLE 1

| | | | Tensile |
|---|---|---|---|
| | | | strength |
| | S1 | L1 | of tab |
| Group | (mm) | (mm) | (MPa) |
| Example 1 | 0.5 | 1.1 | 300 |
| Example 2 | 0.55 | 1.1 | 310 |
| Example 3 | 0.6 | 1.1 | 320 |
| Example 4 | 0.65 | 1.1 | 330 |
| Example 5 | 1 | 1.2 | 330 |
| Example 6 | 1.5 | 1.2 | 320 |
| Example 7 | 2 | 1.2 | 310 |
| Example 8 | 0.2 | 1.1 | 200 |
| Example 9 | 0.4 | 1.1 | 220 |
| Example 10 | 2.5 | 1.4 | 280 |
| Example 11 | 3 | 1.4 | 260 |

From Examples 8-9, it can be seen that when S1 is less than 0.5 mm, the tensile strength of the tab 20 is weaker, indicating that the welding reliability of the first weld mark 41 and the second weld mark 42 is affected.

From Examples 10-11, it can be seen that when S1 is greater than 2 mm, it leads to a longer extension length of the tab segment between the first weld mark 41 and the second weld mark 42, resulting in space waste. When S1 is greater than 2 mm, the first weld mark 41 and the second weld mark 42 overlap in the second direction, which not only leads to space waste but also causes weld interference, reducing welding reliability.

From Examples 1-7, it can be seen that by defining 0.5 mm≤S1≤2 mm, the risk of interference between the first weld mark 41 and the second weld mark 42 during the welding process is reduced, the welding reliability is improved, and it facilitates further improving the space utilization rate of the tab 20 on the side of the electrode assembly 10, thereby contributing to increasing the energy density of the battery cell 100.

In addition, those skilled in the art may make other changes within the spirit of the present application, and of course, these changes made in accordance with the spirit of the present application should be included within the scope disclosed by the present application.

What is claimed is:

1. A battery cell, wherein the battery cell comprises:
an electrode assembly;
a tab comprising a plurality of tab units, wherein one ends of the plurality of tab units are arranged along a first direction and respectively connected to one side of the electrode assembly in a second direction; another ends of the plurality of tab units are gathered and form a root, a first connecting portion, a first extending portion, a second connecting portion, and a second extending portion that are sequentially connected; the root, the first extending portion, and the second extending portion are sequentially arranged on one side of the electrode assembly along the second direction; the first connecting portion and the second connecting portion are respectively bent, the plurality of tab units are interconnected and provided with a first weld mark, one end of the first weld mark is located at the root, another end of the first weld mark extends through the first connecting portion to the first extending portion, the first direction is a thickness direction of the electrode assembly, and the second direction is perpendicular to the first direction; and
a tab lead, wherein a portion of the tab lead and the second extending portion overlap in the second direction, and a second weld mark is provided in the overlapping region of the tab lead and the second extending portion.

2. The battery cell according to claim 1, wherein along an extending direction of the tab the extending direction is from the root to the second extending portion, a spacing S1 between the first weld mark and the second weld mark satisfies: 0.5 mm≤S1≤2 mm; and
along the second direction, a projection of a portion of the first weld mark located at the first extending portion and the second weld mark do not overlap.

3. The battery cell according to claim 2, wherein 0.5 mm≤S1≤0.65 mm.

4. The battery cell according to claim 1, wherein along the second direction, a projection of the tab and a projection of the tab lead are respectively located within a projection range of the electrode assembly.

5. The battery cell according to claim 1, wherein the tab lead comprises a third extending portion, a third connecting portion, and a fourth extending portion that are sequentially connected; the third extending portion is arranged along the second direction on a side of the second extending portion facing the electrode assembly, at least a portion of the third extending portion and the second extending portion overlap in the second direction, the second weld mark is provided in the overlapping region of the third extending portion and the second extending portion, the third connecting portion is bent, and the fourth extending portion extends away from the electrode assembly along the second direction.

6. The battery cell according to claim 5, wherein the first extending portion, the second extending portion, and the third extending portion respectively extend along the first direction.

7. The battery cell according to claim 5, wherein along the first direction, a thickness H1 of the electrode assembly satisfies: H1≤3.8 mm.

8. The battery cell according to claim 7, wherein 2.5 mm≤H1≤3.8 mm.

9. The battery cell according to claim 7, wherein along the first direction, a height H2 from an endpoint where the third connecting portion connects to the third extending portion to a surface of the fourth extending portion facing away from the third extending portion satisfies: 0.5 mm≤H2≤0.7 mm.

10. The battery cell according to claim 9, wherein 0.58 mm≤H2≤0.62 mm.

11. The battery cell according to claim 7, wherein along the first direction, a height H3 from an endpoint where the third extending portion connects to the third connecting portion to a surface of the second connecting portion facing away from the second extending portion satisfies: 1 mm≤H3≤1.5 mm.

12. The battery cell according to claim 11, wherein 1.1 mm≤H3≤1.3 mm.

13. The battery cell according to claim 11, wherein the first extending portion extends along the first direction, the second extending portion and the third extending portion both extend along a same direction inclined relative to the first direction; and along an extending direction of the tab, the extension length W1 from the endpoint where the third extending portion connects to the third connecting portion to the surface of the second connecting portion facing away from the second extending portion and an inclination angle α of the second extending portion and the third extending portion relative to the first direction satisfy: α>arccos(H3/W1).

14. The battery cell according to claim 1, wherein the electrode assembly comprises a first electrode plate, a separator, and a second electrode plate sequentially stacked along the first direction; the first electrode plate comprises a first current collector, a first active material layer, and a conductive member; the first current collector comprises a first section and a second section sequentially arranged in the second direction, the first active material layer is connected to the first section; when viewed along the first direction, one end of the conductive member is connected to the second section, and another end of the conductive member protrudes beyond the first current collector in the second direction and is connected to the tab unit.

15. The battery cell according to claim 2, wherein the electrode assembly comprises a first electrode plate, a separator, and a second electrode plate sequentially stacked along the first direction; the first electrode plate comprises a first current collector, a first active material layer, and a conductive member; the first current collector comprises a first section and a second section sequentially arranged in the second direction, the first active material layer is connected to the first section; when viewed along the first direction, one end of the conductive member is connected to the second section, and another end of the conductive member protrudes beyond the first current collector in the second direction and is connected to the tab unit.

16. The battery cell according to claim 14, wherein the first current collector comprises a support layer, a first conductive layer, and a second conductive layer; the first conductive layer and the second conductive layer are respectively arranged on two sides of the support layer in the first direction; the first active material layer is connected to the first conductive layer and/or the second conductive layer located at the first section; and the conductive member is connected to the first conductive layer and/or the second conductive layer located at the second section.

17. The battery cell according to claim 16, wherein the support layer is made of a polymer insulating material; the polymer insulating material includes one or more of polyethyleneterephthalate, polypropylene, polyethylene, polyimide, polyetherketone, polyphenylenesulphide.

18. The battery cell according to claim 14, wherein the battery cell further comprises an insulating member, one end of the insulating member is adhered to a surface of the first active material layer facing away from the first current collector and another end of the insulating member is adhered to a surface of the conductive member facing away from the first current collector.

19. The battery cell according to claim 1, wherein a tensile strength of the tab is 200 MPa to 330 MPa.

20. An electrical apparatus comprising the battery cell according to claim 1.
